(19) United States
(12) Patent Application Publication
(10) Pub. No.: US 2003/0210293 A1
(43) Pub. Date: Nov. 13, 2003

(54) Image forming apparatus

(76) Inventors: Hiromitsu Tsutsui, Nara-shi (JP); Ryoichi Kawai, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/373,962

(22) Filed: Feb. 27, 2003

(30) Foreign Application Priority Data
Feb. 28, 2002 (JP) P2002-54575
Feb. 14, 2003 (JP) P2003-36888

(51) Int. Cl. B41J 29/38

(52) U.S. Cl. 347/16; 347/37

(57) ABSTRACT

It is an object of the present invention to provide an image forming apparatus capable of improving the quality of an image recorded on a recording medium and simplifying the structure. A release mechanism forces a carriage possible state of an upstream carrying mechanism to be released in at least a stop state before recording paper is separated downstream from an upstream carrying mechanism, and thereafter, printing is performed on the recording paper, thus minimizing the difference between the contact pressure of the upstream carrying mechanism to the recording paper and that of the downstream carrying mechanism, and variations in carrying speed due to the changes of the carrying position of the recording paper to prevent variations in the volume of carriage of the recording paper.

### BACKGROUND OF THE INVENTION

1. Field of the Invention

The present invention relates to an image forming apparatus and a technique suitable for use in a paper feed mechanism of an ink-jet printer and so on.

2. Description of the Related Art

Ink-jet printers are in practical use, which serve as image forming apparatus for recording an image on recording paper by moving an ink cartridge in a main scanning direction of the recording paper via a carriage in accordance with a print command issued by a personal computer and by discharging ink drops in a desired print position of a record object while carrying the recording paper in a subscanning direction. FIG. 18 is a side view of a related-art ink-jet printer 1. FIGS. 19A and 19B are sectional views showing the relationship between an upstream carrying mechanism 2 and a recording paper 3. FIG. 20 is a diagram for explaining the relative position of each part to a platen roller 4 in the related-art inkjet printer 1.

For printing on the object recording paper 3, when a plurality of sheets of recording paper 3 is set in a recording paper tray 5 and a print command is then issued by a personal computer or the like, print data is transferred to the ink-jet printer 1. Subsequently, a preset maintenance operation is performed to an ink cartridge 6, and the ink cartridge 6 is then moved from a home position to a print start position. Then, a sheet of recording paper 3 is separated and is taken out from the recording paper tray 5 by a recording-paper separating section 7. The one sheet of recording paper 3 is carried by a paper feed roller 8 to a position where a recording-paper sensor 9 is turned on, and the recording paper 3 is detected by the turning-on of the recording-paper sensor 9.

Thereafter, the recording paper 3 is carried through a fixed distance until it is brought into contact with a platen roller 4, and is then stopped. Subsequently, the drive path of the paper feed roller 8 is switched to the drive path of the platen roller 4 by a drive system (not shown). The recording paper 3 is carried between the platen roller 4 and a recording-paper press roller 10 which is in contact pressure with the platen roller 4, and it is then carried to a position where the end thereof is in a print start position by the rotation of the platen roller 4 and stops there for a while. The ink cartridge 6 emits ink for printing on the basis of print data while moving in a main scanning direction perpendicular to the carrying direction of the recording paper 3 from the print start position by a carriage (not shown). After completion of printing of one line, the ink cartridge 6 returns to a predetermined standby position. Exact one line of the recording paper 3 is then carried in the carrying direction, that is, a subscanning direction by the rotation of the platen roller 4, and printing of the second line is performed in a stopped state, as in the above described procedure.

An eject roller 11 and an eject pinch roller 12 (also referred to as a star roller) are disposed along the carrying path and downstream of an ink emitting position of the ink cartridge 6, and are rotated in synchronization with the rotation of the platen roller 4. The contact pressure force between the eject roller 11 and the eject pinch roller 12 is set smaller than that between the platen roller 4 and the recording-paper press roller 10. The recording paper 3 is carried in the subscanning direction on a line-by-line basis by the platen roller 4 while being printed on the basis of print data. Subsequently, when the end of the recording paper 3 reaches the eject roller 11, the recording paper 3 is carried in the subscanning direction line by line by the platen roller 4 and the eject roller 11 and printed with ink emitted from the ink cartridge 6 on the basis of the print data.

When the rear end of the recording paper 3 has passed through the recording-paper sensor 9, to recording-paper sensor 9 is turned off. Also after the shutoff of the recording-paper sensor 9, printing is performed on the recording paper 3 on the basis of the print data. After that, when printing is continued on the basis of the print data, the rear end of the recording paper 3 is separated from the platen roller 4, and printing is performed onto the rear end of the recording paper 3 while the recording paper 3 is carried only by the eject roller 11, and the printing then terminates. Subsequently, the recording paper 3 is ejected onto a recording paper tray 13 by the eject roller 11.

Such a prior art has a problem in that the carrying speed of the recording paper 3 varies slightly at the moment when the rear end of the recording paper 3 is separated from the platen roller 4 to cause variations in the volume of carriage of the recording paper 3. FIG. 21 is a plan view schematically showing print dots with the related-art ink-jet printer 1. In the drawings, black circles and white circles indicate the dots of emitted ink. Since the print position is displaced from the regular position because of the variations in the volume of carriage of the recording paper 3, as shown in FIG. 21, lateral stripes or color irregularities during color printing occur in the main scanning direction of the recording paper 3. More specifically, in a normal printing mode, ink is emitted from the nozzle of the ink cartridge 6 on the basis of print data to print black circles and white circles alternately (refer to FIG. 8). On the other hand, in the prior-art, black circles and white circles are not printed alternately because of the variations in the volume of carriage of the recording paper 3, thus causing the black circles and the white circles to be separated or overlapped. Therefore, lateral stripes or color irregularities during color printing occur in the main scanning direction of the recording paper 3. In order to prevent the lateral stripes or color irregularities, for example, there is a method in which recording paper that is longer in the subscanning direction than that of prescribed size is prepared so that the rear end of the recording paper is not separated from the platen roller during printing; and an unnecessary part of the rear end is then cut off after completion of the printing. However, it is necessary to prepare longer recording paper than that of a prescribed size and also to cut off an unnecessary part of the recording paper, causing low work efficiency.

### SUMMARY OF THE INVENTION

Accordingly, it is an object of the present invention to provide an image forming apparatus capable of improving the quality of an image recorded on a recording medium and simplifying the structure.

The invention provides an image forming apparatus comprising recording means for recording a desired image on a recording medium; recording-medium carrying means capable of carrying the recording means, the recording-medium carrying means including upstream carrying means arranged along a carrying path and upstream of the recording means and downstream carrying means arranged along the carrying path and downstream of the recording means; release means capable of releasing a carriage-possible state of the recording medium in the upstream carrying means; and control means for forcibly releasing the carriage-possible state to control a carrying force to be applied to the recording medium before the recording medium is separated downstream from the upstream carrying means, based on predetermined recording-medium carrying position information.

According to the invention, when a desired image is recorded on the recording medium, the recording medium is carried to the upstream carrying means of the recording means, and the image is then recorded on the recording medium by means of the recording means and the upstream carrying means. In a state where the recording medium is carried to the downstream carrying means of the recording means, an image is recorded on the recording medium in cooperation with the recording means, the upstream carrying means, and the downstream carrying means. The control means forcibly releases the carriage-possible state of the upstream carrying means to control the carrying force to be applied to the recording medium before the recording medium is separated downstream from the upstream carrying means on the basis of the predetermined recording-medium carrying position information.

Particularly, the carriage-possible state is forcibly released before the recording medium is separated downstream from the upstream carrying means. Therefore, subtle variations in carrying speed of the recording medium at the moment when the recording medium is separated from the upstream carrying means can be prevented. Accordingly, variations in the volume of carriage of the recording medium can be prevented.

In the invention it is preferable that the release means includes a drive source for applying a driving force for releasing the carriage-possible state to the upstream carrying means and a driving-force transmission mechanism for transmitting the driving force from the drive source to the upstream carrying means to release the carriage-possible state.

According to the invention, the driving force from the drive source is transmitted to the upstream carrying means through the driving-force transmission mechanism. Thus, the carriage-possible state of the upstream carrying means can be released.

Further the invention provides an image forming apparatus comprising recording means for recording a desired image on a recording medium; recording-medium carrying means capable of carrying the recording medium, the recording-medium carrying means including upstream carrying means arranged along a carrying path and upstream of the recording means and downstream carrying means arranged along the carrying path and downstream of the recording means; and a control mechanism for controlling a carrying force to be applied to the recording medium on the basis of predetermined recording-medium carrying position information.

According to the invention, when a desired image is recorded on the recording medium, the recording medium is carried to the upstream carrying means of the recording means, and then the image is recorded on the recording medium in cooperation with the upstream carrying means. In a state where the recording medium is carried to the downstream carrying means of the recording means, an image is recorded on the recording medium in cooperation with the upstream carrying means and downstream carrying means in a manner similar to the above. Thereafter, the control mechanism controls a carrying force to be applied to the recording medium on the basis of the predetermined recording-medium carrying position information, and in that state, an image is recorded on the recording medium.

Further according to the invention, variations in carrying speed due to the changes of a recording-medium carrying position can be minimized to thereby prevent variations in the volume of carriage of the recording medium. Thus, displacement of the recording medium from a regular position can be prevented to ensure prevention of the occurrence of lateral stripes or color irregularities during color printing in the main scanning direction of the recording medium.

In the invention it is preferable that the control mechanism can be controlled with a drive source for maintaining the recording means.

According to the invention, since the control mechanism is controlled with a drive source for maintaining the recording means, manufacturing costs of the image forming apparatus can be reduced.

In the invention it is preferable that the upstream carrying means has a pair of rotating rollers which can sandwich the recording medium and can be rotated, and the control mechanism has a function of separating a first rotating roller which is elastically biased to a second rotating roller therefrom against the biasing force.

According to the invention, preferably, after the first rotating roller which is elastically biased to the second rotating roller has been separated therefrom against the biasing force with the control mechanism, an image is recorded on the recording medium.

According to the invention, the quality of the image recorded on the recording medium can be improved with a simplified structure.

The invention provides an image forming apparatus comprising recording means for recording a desired image on a recording medium; recording-medium carrying means capable of carrying the recording medium, the recording-medium carrying means including upstream carrying means arranged along a carrying path and upstream of the recording means and downstream carrying means arranged along the carrying path and downstream of the recording means; and release means for forcing a carriage-possible state of the upstream carrying means to be released in a state where the recording medium can be carried by the cooperation of the upstream carrying means and the downstream carrying means and in at least a stopped state before the recording medium is separated downstream from the upstream carrying means.

According to the invention, preferably, when a desired image is recorded on the recording medium, the recording medium is carried to the upstream carrying means of the recording means, and an image is then recorded on the recording medium in cooperation with the upstream carrying means. In a state where the recording medium is carried to the downstream carrying means of the recording means, an image is recorded on the recording medium in cooperation with the upstream carrying means and downstream carrying means in the same way. In a state where the recording medium can be carried by the cooperation of the upstream carrying means and the downstream carrying means and in at least a stopped state before the recording medium is separated downstream from the upstream carrying means, the release means forces the carriage-possible state of the upstream carrying means to be released. Thereafter, an image is recorded on the recording medium.

According to the invention, the difference between the contact pressure of the upstream carrying means to the recording medium and that of the downstream carrying means, and the variations in carrying speed due to the changes of the carrying position of the recording medium can be minimized, thus preventing variations in the volume of carriage of the recording medium. Accordingly, displacement of the recording medium from a regular position can be prevented, thus ensuring prevention of the occurrence of lateral stripes or color irregularities during color printing in the main scanning direction of the recording medium.

In the invention it is preferable that the release means can be released with a drive source for maintaining the recording means.

According to the invention, since the release means is released with the drive source for maintaining the recording means, manufacturing costs of the image forming apparatus can be reduced.

In the invention it is preferable that the upstream carrying means includes a pair of rotating rollers which can sandwich the recording medium and can be rotated, and the release means has a function of separating a first rotating roller which is elastically biased to a second rotating roller therefrom against the biasing force.

According to the invention, preferably, the first rotating roller elastically biased to the second rotating roller is separated therefrom against the biasing force with the release means, and then an image is recorded on the recording medium.

According to the invention, the quality of an image recorded on the recording medium can be improved with a simplified structure.

### BRIEF DESCRIPTION OF THE DRAWINGS

Other and further objects, features, and advantages of the invention will be more explicit from the following detailed description taken with reference to the drawings wherein:

FIG. 1 is a schematic plan view of an image forming apparatus according to an embodiment of the present invention;

FIG. 2 is a block diagram of a control system;

FIG. 3 is a perspective view for explaining a cam mechanism and so on;

FIG. 4 is a side view of a peripheral part of an upstream carrying mechanism;

FIG. 5 is an enlarged view of essential parts showing the relationship between the cam mechanism and a recording-paper press roller;

FIG. 6 is a diagram corresponding to FIG. 5, showing a state after the activation of the cam mechanism;

FIG. 7 is a flowchart of a series of operation sequences;

FIG. 8 is a schematic plan view of print dots with the image forming apparatus according to the embodiment of the invention;

FIG. 9 is a side view of a peripheral part of an upstream carrying mechanism according to another embodiment of the invention;

FIG. 10 is an enlarged view of essential parts showing the relationship between a plunger and the recording-paper press roller;

FIG. 11 is a diagram corresponding to FIG. 9, depicting the operating state of the plunger;

FIG. 12 is a diagram corresponding to FIG. 10, depicting the operating state of the plunger;

FIG. 13 is an enlarged side view of the shape of the essential parts of a rotating arm 65;

FIG. 14 is a partial side view of a release mechanism 31B and the periphery thereof according to another embodiment of the present invention;

FIG. 15 is a side view showing the relationship between a drive source and a driving-force transmission mechanism 70 when the carriage-possible state of a recording medium is released;

FIG. 16 is a schematic plan view showing the operation of the driving-force transmission mechanism 70 when the carriage-possible state of the recording medium is released;

FIG. 17 is a schematic side view showing the relationship between the driving-force transmission mechanism 70 and an upstream carrying mechanism 22;

FIG. 18 is a side view of a related-art ink-jet printer 1;

FIGS. 19A and 19B are sectional views showing the relationship between the upstream carrying mechanism 2 and recording paper 3;

FIG. 20 is a diagram for explaining the relative position of each part to a platen roller 4 in the related-art ink-jet printer 1; and

FIG. 21 is a plan view schematically showing print dots with the related-art ink-jet printer 1.

### DETAILED DESCRIPTION OF THE PREFERRED EMBODIMENTS

Now referring to the drawings, preferred embodiments of the invention are described below.

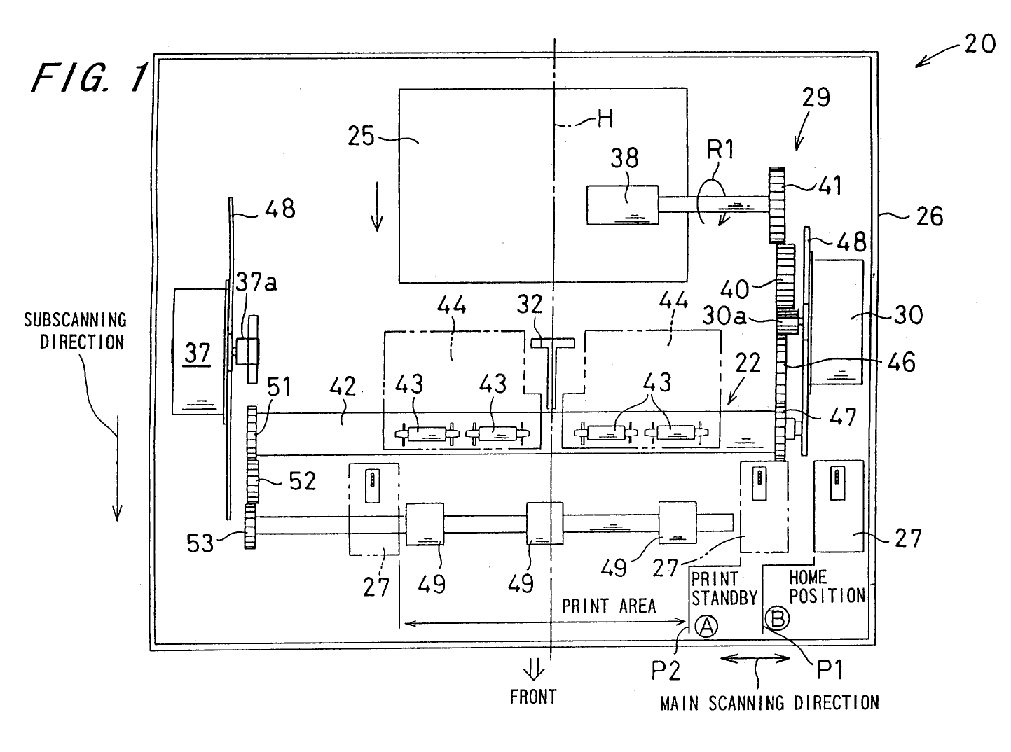

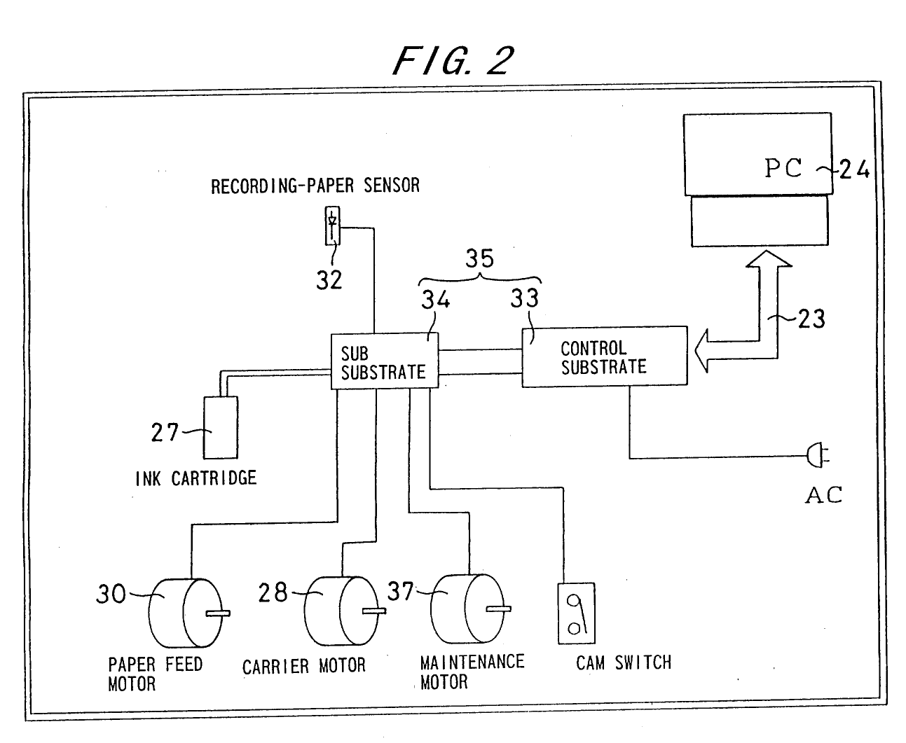

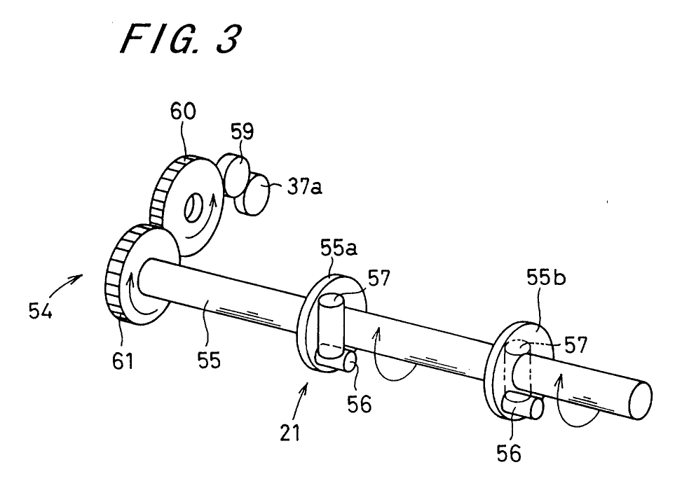

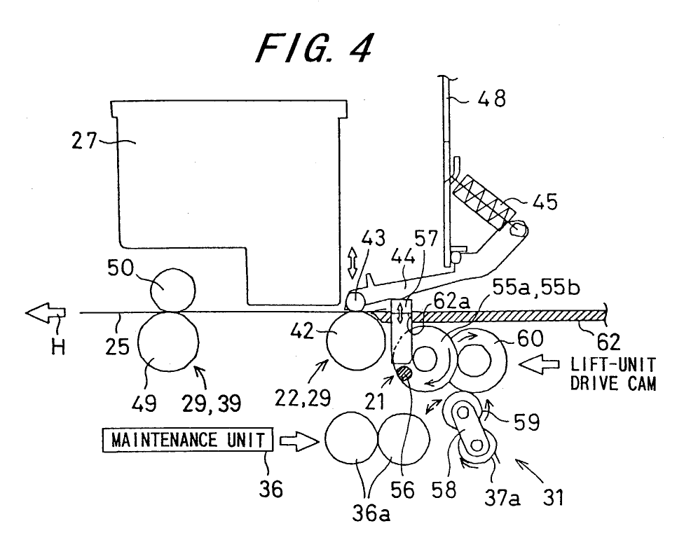

FIG. 1 is a schematic plan view of an image forming apparatus 20 according to an embodiment of the present invention. FIG. 2 is a block diagram of a control system. FIG. 3 is a perspective view for explaining a cam mechanism 21 and so on. FIG. 4 is a side view of a peripheral part of an upstream carrying mechanism 22. The embodiment is an example of the application of the image forming apparatus 20 to an ink-jet printer. The ink-jet printer 20 is connected to a personal computer 24 through a dedicated cable 23 for example, and prints on recording paper 25 serving as a recording medium in accordance with a print command issued by the personal computer 24. The personal computer 24 has a printer driver installed for driving the ink-jet printer 20. Hereinafter, the downstream parts of a carrying path H of the recording paper 25 are defined as front, the upstream parts as rear, and the left and right as the left and right, in FIG. 1.

The ink-jet printer 20 primarily includes a cover member 26, an ink cartridge 27, a carriage (not shown) and a carriage drive source 28, a carrying mechanism 29 and a carrying-mechanism drive motor 30, a control mechanism 31 (release mechanism 31), a recording-paper sensor 32, a controller 35 served as control means having a control substrate 33 and a sub substrate 34, a maintenance unit 36, and a maintenance motor 37. The cover member 26 has a recording paper tray capable of loading a plurality of sheets of recording paper 25, mounted such that it is inclined upward toward the rear on the back, and has a recording-paper output tray for ejecting and holding the printed recording paper 25, such that it projects forward at the lower end of the front. The recording paper tray has a recording-paper separating section for separating the plurality of sheets of recording paper 25 loaded on the recording paper tray, at the lower end.

The ink cartridge 27 has a detachable ink tank (not shown) in the cover member 26. The ink cartridge 27 can be detachable from the carriage and can freely be moved laterally, that is, in the main scanning direction via the carriage. The controller 35 drives the carriage drive source 28 (carrier motor 28) to emit ink drops in a desired print position of the object recording paper 25 while moving the ink cartridge 27 in the main scanning direction with the carriage. The ink cartridge 27, the carriage, and the carrier motor 28 correspond to recording means. The controller 35 corresponds to control means.

The carrying mechanism 29 serving as recording-medium carrying means capable of carrying the recording paper 25 has a paper feed roller 38, an upstream carrying mechanism 22, and a downstream carrying mechanism 39 along the carrying path H in sequence, which are mounted in the cover member 26. The paper feed roller 38 having a lateral rotation shaft center is rotatably disposed directly ahead of the recording paper tray, and is rotated clockwise R1, seen from the right, via gears 40 and 41 by the carrying-mechanism drive motor 30 (also referred to as a paper feed motor 30). The front-row recording paper 25 of the plurality of sheets of recording paper 25 loaded on the recording paper tray is pressed by the paper feed roller 38 at a fixed pressure, and the paper feed roller 38 is rotated clockwise R1 by the drive motor 30 in this state; thus, the recording paper 25 is fed to the upstream carrying mechanism 22 one by one.

The upstream carrying mechanism 22 is disposed upstream of the ink cartridge 27 along the carrying path H. The upstream carrying mechanism 22 has a pair of platen rollers 42 serving as rotating rollers, a plurality of recording-paper press rollers 43, a plurality of oscillating plates 44, and a plurality of coil springs 45. More specifically, each of the recording-paper press rollers 43 and the platen rollers 42 has a lateral rotation shaft center, being rotatably arranged in parallel vertically, and is capable of sandwiching the recording paper 25, which is carried substantially horizontally, from above and below. After the drive path (a pinion 30a and gears 40 and 41) of the paper feed roller 38 has been switched to the drive path (the pinion 30a and gears 46 and 47) of the platen roller 42 by a drive system (not shown), the platen roller 42 is rotated counterclockwise, shown in FIG. 4, via the gears 46 and 47 by the drive motor 30.

The cover member 26 has therein a substantially vertical frame member 48, at the end of which the plurality of oscillating plates 44 is disposed laterally with proper separations and supported so as to oscillate vertically. The coil springs 45 are disposed between the respective ends of the oscillating plate 44 and the frame member 48, by the spring force of which the recording-paper press rollers 43 rotatably supported by the other ends of the oscillating plates 44 are bought into contact with the platen rollers 42 at a fixed contact pressure. Accordingly, when the platen rollers 42 are rotated counterclockwise, with the recording-paper press roller 43 in contact with the platen rollers 42, the recording-paper press rollers 43 are driven to rotate clockwise; thus, and the recording paper 25 sandwiched by the recording-paper press rollers 43 and the platen rollers 42 is fed downstream of the carrying path H for printing.

The downstream carrying mechanism 39 is disposed downstream of the recording means along the carrying path H. The downstream carrying mechanism 39 carries the recording paper 25 fed from the upstream carrying mechanism 22 and ejects it onto the recording paper tray finally. The downstream carrying mechanism 39 includes an eject rollers 49 and eject pinch roller 50 each having a lateral rotation shaft center. The eject roller 49 and the eject pinch roller 50 are rotatably arranged in parallel vertically, and are capable of sandwiching the recording paper 25, which is carried substantially horizontally, from above and below. The eject roller 49 is rotated counterclockwise, shown in FIG. 4, via gears 51, 52, and 53 in synchronization with the platen roller 42 by the drive motor 30. The eject pinch roller 50 is arranged in contact with the eject roller 49 at a fixed pressure all the time. Accordingly, when the eject roller 49 is rotated counterclockwise, the eject pinch roller 50 is driven to rotate clockwise; thus, the recording paper 25 sandwiched by the eject pinch roller 50 and the eject roller 49 is fed downstream of the carrying path H. The contact pressure between the eject roller 49 and the eject pinch roller 50 is set smaller than the contact pressure between the platen roller 42 and the recording-paper press roller 43.

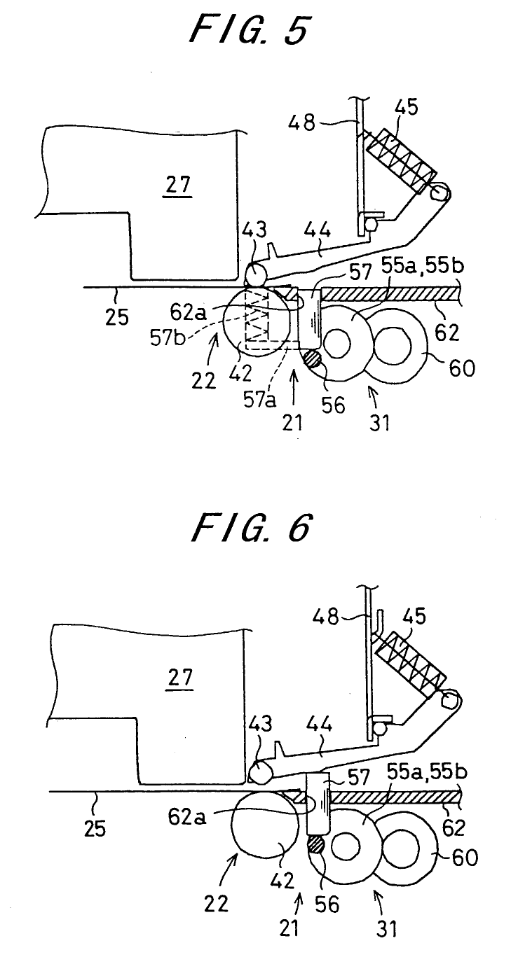

FIG. 5 is an enlarged view of essential parts showing the relationship between the cam mechanism 21 and one of the recording-paper press rollers 43 and FIG. 6 is a diagram corresponding to FIG. 5, showing a state after the activation of the cam mechanism 21. The control mechanism 31, that is, the release mechanism 31 has a function of controlling a carrying force to be applied to the recording paper 25 on the basis of prescribed carrying position information of the recording paper 25, which will be discussed later. In other words, the release mechanism 31 has a function of separating the recording-paper press roller 43 which is biased by a spring force toward the platen roller 42 therefrom against the spring force (biasing force) of the coil spring 45 using a maintenance motor 37 serving as a drive source for a maintenance unit 36 for maintaining the recording means. The release mechanism 31 includes the maintenance motor 37, a gear mechanism 54 which is a driving force transmission mechanism, a shaft 55, a cylindrical cam 56, and a forcing arm 57.

The frame member 48 has the maintenance motor 37, to the motor shaft of which a pinion 37a is fixed, and a planet gear 59 is integrated to the pinion 37a with a bracket 58. The planet gear 59 is engaged with the pinion 37a and can be brought into and out of contact with a maintenance drive section 36a of the maintenance unit 36. The planet gear 59 transmits a driving force to a drive cam (not shown) of the maintenance unit 36, with the planet gear 59 in contact with the maintenance drive section 36a. The planet gear 59 can be brought into and out of contact with an idle gear 60 and transmits a driving force to the cylindrical cam 56, with the planet gear 59 in contact with the idle gear 60. In other words, the planet gear 59 has a structure in which a maintenance position to transmit a driving force to the maintenance unit 36 and an idle position (refer to FIG. 4) to transmit a driving force to the cylindrical cam 56 can be switched. In the interior of the cover member 26, the idle gear 60 having a lateral rotation shaft center is rotatably supported near the maintenance motor 37 and below the oscillating plate 44, with which a gear 61 is engaged. The gear mechanism 54 includes the pinion 37a, the planet gear 59, the idle gear 60, and the gear 61.

In the interior of the cover member 26, the shaft 55 having a lateral rotation shaft center is rotatably supported below the oscillating plate 44, to one end of which the gear 61 is fixed. A plurality of flanges 55a and 55b is mounted at the lower positions that correspond to the plurality of oscillating plates 44 and along the length of the shaft 55, and the cylindrical cam 56 protruding a fixed short distance is attached to part of each of the flanges 55a and 55b. In the interior of the cover member 26, a horizontal carrying plane 62 for the recording paper 25 has a plurality of the substantially cylindrical forcing arms 57 such that they can be slid vertically. A plurality of arm slide holes 62a is formed in the carrying plane 62, under the oscillating plates 44 and near the recording-paper press roller 43. Each of the arm slide holes 62a has the forcing arm 57. A flange 57a is formed at the lower end of each forcing arm 57, and a compression spring 57b is interposed between the carrying plane 62 and the flange 57a. When the release mechanism 31 is not operated, the forcing arms 57 come in and out of the respective arm slide holes 62a by the spring force of the compression spring 57b (refer to FIG. 5), and when the release mechanism 31 is operated, they project from the arm slide holes 62a partly by the rotation of the gear 61 through a fixed angle, that is, the shaft 55, with them in contact with the cylindrical cams 56 (refer to FIG. 6). Accordingly, the lower end of each oscillating plate 44, near the recording-paper press roller 43, is forced to move upward by the forcing arm 57 against the spring force of the coil spring 45; therefore, the recording-paper press rollers 43 are relatively separated from the platen rollers 42.

The frame member 48 has the recording-paper sensor 32 at the substantial center in the main scanning direction of the recording paper 25. The recording paper 25 is carried by the paper feed roller 38 to a position where the recording-paper sensor 32 is turned on; subsequently it is carried until it is brought into contact with the platen roller 42 and is then stopped. After most of the recording paper 25 has been printed, when the rear end of the recording paper 25 has passed through the recording-paper sensor 32, with the rear end of the recording paper 25 sandwiched by the platen roller 42 and the recording-paper press roller 43, the recording-paper sensor 32 is turned off. Accordingly, the controller 35 activates the release mechanism 31 to release the sandwiched state while temporarily stopping the carriage of the recording paper 25, while sandwiching the rear end of the recording paper 25. In other words, the release mechanism 31 forces the carriage possible state of the upstream carrying mechanism 22 to be released in a state where the recording paper 25 can be carried by the cooperation of the upstream carrying mechanism 22 and the downstream carrying mechanism 39 and in at least a stopped state of the recording paper 25 state before it is separated downstream from the upstream carrying mechanism 22.

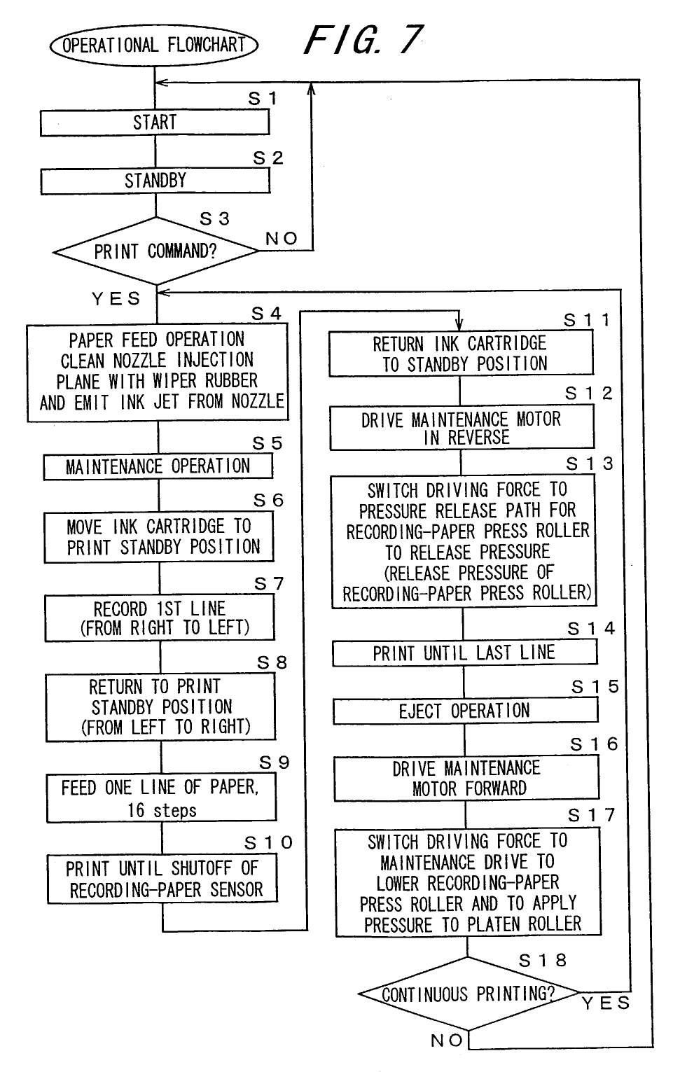

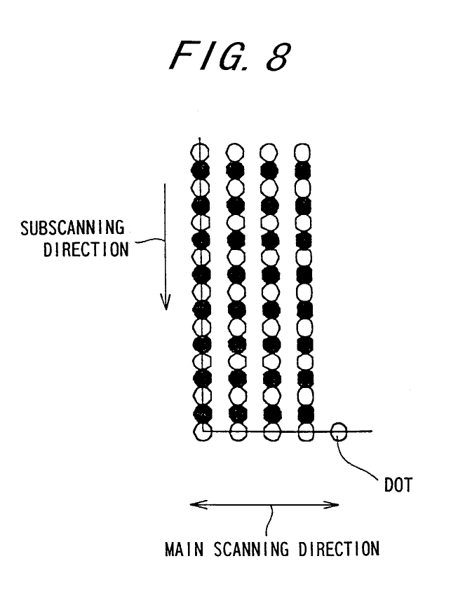

FIG. 7 is a flowchart of a series of operation sequences performed by the controller 35, where Si (i=1, 2, 3, . . .) shows the step. FIG. 8 is a schematic plan view of print dots with the ink-jet printer 20 according to the embodiment of the invention. In step 1, the operation sequence is started, and in step 2, the process enters a standby state. In step 3, a determination is made as to whether a print command is issued from the personal computer 24. When a print command is issued, the process proceeds to step 4, where the paper feed operation for the recording paper. 25 is performed to carry the end of the recording paper 25 to a print start position by the upstream carrying mechanism 22 and is then stopped; a nozzle injection surface of the ink cartridge 27 arranged in home position P1 is cleaned with a wiper rubber (not shown); and a jet of ink is emitted from the nozzle. Subsequently, in step 5, the maintenance motor 37 is driven to maintain the ink cartridge 27 with the maintenance unit 36. Thereafter, the process proceeds to step 6, where the ink cartridge 27 is moved from the initial home position P1 to print standby position P2 with the carriage drive source 28. The maintenance includes a method of removing a rubber cap (not shown) for preventing an ink emitting nozzle from drying from the nozzle, moving a rubber plate wiper upward, moving the nozzle, and scrubbing dirt such as ink dregs adhered to the ink emitting plane of the nozzle with the wiper.

In step 7, the ink cartridge 27 emits ink while moving from the print start position for the recording paper 25, from the right to the left in the main scanning direction, on the basis of print data and various preset print data such as a desired record object of plain paper, a postcard, a picture and so on, and a desired standard size of A4, A5 and so on of recording paper 25. After completion of printing of the first line, in step 8, the ink cartridge 27 moves from the left to the right in the main scanning direction to return to the print standby position P2. In step 9, the upstream carrying mechanism 22 carries exact one line of the recording paper 25 downstream in the carrying direction, that is, in the subscanning direction. Thereafter, the second line of printing is performed in the same way. As described above, the recording paper 25 is carried to the eject roller 49 line by line in sequence by the platen rollers 42 of the upstream carrying mechanism 22 and, in each line, it is printed in the main scanning direction on the basis of the print data and the preset print data. When the recording paper 25 is carried to the eject roller 49 of the downstream carrying mechanism 39, it is carried in the subscanning direction line by line in sequence by the cooperation between the upstream carrying mechanism 22 and the downstream carrying mechanism 39 and, in each line, it is printed in the main scanning direction on the basis of the print data and the preset print data.

Subsequently, in step 10, the rear end of the recording paper 25 passes through the recording-paper sensor 32, and when the controller 35 has detected that the recording-paper sensor 32 was turned off, the carriage of the recording paper 25 in the subscanning direction is stopped to terminate one line of printing. Then, in step 11, the ink cartridge 27 is returned to the print standby position P2 with the carrier motor 28. At that time, the rear end of the recording paper 25 is sandwiched by the platen rollers 42 and the recording-paper press rollers 43. Thereafter, in steps 12 and 13, the maintenance motor 37 is rotated clockwise, shown in FIG. 4, and the torque is transmitted to the idle gear 60 and the gear 61 through the planet gear 59. This rotates the gear 61 and the shaft 55, and then rotates the cylindrical cam 56 in synchronization with the rotation, thereby pushing the forcing arm 57 upward. Therefore, the lower end of the oscillating plate 44 near the recording-paper press roller 43 is forced up by the forcing arm 57 against the spring force of the coil spring 45. Thus, the recording-paper press rollers 43 are relatively separated from the platen rollers 42. In other words, the carriage possible state of the upstream carrying mechanism 22 is forced to be released.

Subsequently, the process proceeds to step 14, where one line of the recording paper 25 is carried by only the downstream carrying mechanism 39 and is printed in the main scanning direction. Thereafter, the recording paper 25 is carried to the last line in the subscanning direction only by the downstream carrying mechanism 39 and is printed on the basis of the print data and the preset print data. In step 15, the printed recording paper 25 is ejected onto the recording-paper output tray by the downstream carrying mechanism 39. In steps 16 and 17, the maintenance motor 37 is rotated counterclockwise, shown in FIG. 4, and the planet gear 59 is switched to the maintenance position to transmit the torque to the maintenance unit 36. Therefore, the forcing arm 57 is retracted into the arm slide hole 62a and, as a result, the recording-paper press roller 43 is moved downward by the spring force of the coil spring 45 to come into contact with the platen roller 42 at a fixed pressure. Subsequently, in step 18, a determination is made as to whether continuous printing is conducted and if the determination is positive, the process returns to step 4. If it is negative, the process returns to step 1. In step 3, also when a print command is not issued from the personal computer 24, the process returns to step 1.

Particularly, the carrying mechanism 29 is stopped for a while before printing on the rear end of the recording paper 25, then, each recording-paper press roller 43 is relatively separated from the platen roller 42 by the release mechanism 31 and, thereafter, the recording paper 25 is carried for printing, to the edge of the rear end of the recording paper 25 on the basis of the print data and the preset print data. Accordingly, the carrying force of the downstream carrying mechanism 39 is larger than that of the upstream carrying mechanism 22 during the operation of the release mechanism 31, thereby decreasing the effects of the carrying force generated from the platen roller 42 and the recording-paper press roller 43. Therefore, the problems of the related art can be prevented that the carrying speed of the recording paper varies slightly to cause variations in the volume of carriage of the recording paper at the moment when the rear end of the recording paper is separated from the platen roller; therefore, the print position is displaced from the regular position to cause lateral stripes or color irregularities during color printing in the main scanning direction of the recording paper. Accordingly, as shown in FIG. 8, black circles and white circles of print dots can be recorded in regular positions without any adverse effects on printing by carriage variations of the recording paper 25 that occur at the moment when the recording paper 25 is separated from the platen roller 42 and the recording-paper press roller 43.

Since the control mechanism 31 is controlled using the drive source 37 of the maintenance unit 36, the manufacturing costs of the ink-jet printer 20 can be reduced. Also, the control mechanism 31 allows printing of the recording paper 25 while the recording-paper press roller 43 which is biased to the platen roller 42 by a spring force is separated therefrom against the biasing force. Therefore, the print quality of the recording paper 25 can be improved with a simplified structure.

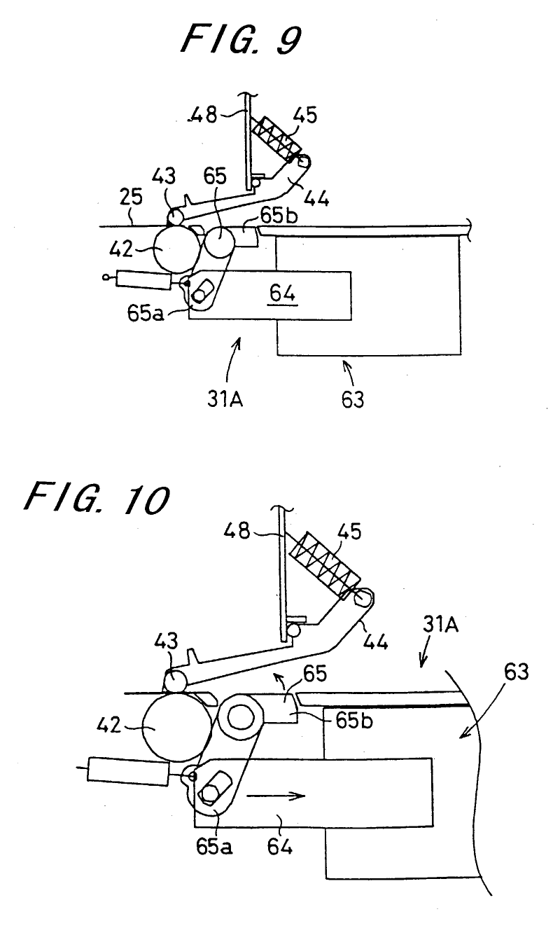

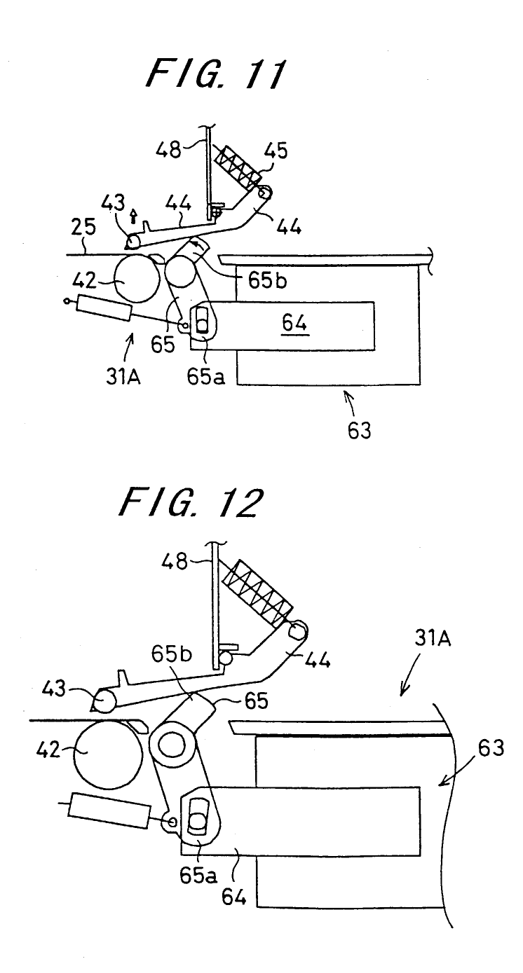

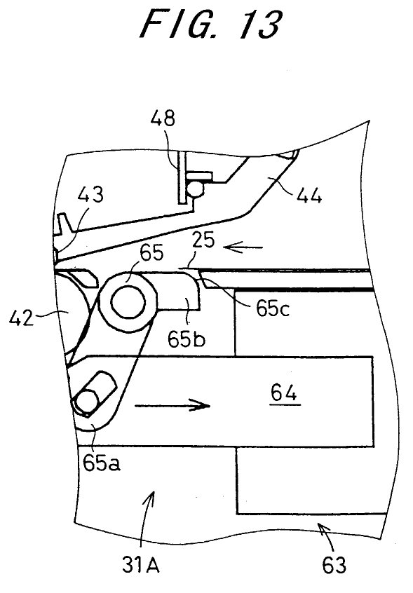

FIG. 9 is a side view of a peripheral part of the upstream carrying mechanism 22 according to another embodiment of the invention. FIG. 10 is an enlarged view of essential parts showing the relationship between a plunger 63 and the recording paper press roller 43. FIG. 11 is a diagram corresponding to FIG. 9, depicting the operating state of the plunger 63. FIG. 12 is a diagram corresponding to FIG. 10, depicting the operating state of the plunger 63. FIG. 13 is a side view showing an enlarged shape of essential parts of a rotating arm 65.

This embodiment is a modification of the above-described embodiment. Accordingly, the same components as those of the above-described embodiment are given the same reference numerals, and a description thereof will be omitted as appropriate. This embodiment is provided with a release mechanism 31A including the electromagnetic plunger 63, an adsorbing iron core 64, and the rotating arm 65 for lifting the recording-paper press roller 43, in place of the release mechanism 31.

In the cover member 26 or the frame member 48, the rotating arm 65 having substantially an L shape seen from the side is rotatably supported around the lateral shaft center in the vicinity of the platen roller 42, and one end 65a of the rotating arm 65 is connected to the end of the iron core 64 of the electromagnetic plunger 63. When the electromagnetic plunger 63 has no power applied thereto, the other end 65b of the rotating arm 65 is supported at a lower position than the carrying plane 62. When the electromagnetic plunger 63 has power applied thereto, the iron core 64 is adsorbed backward to draw the end 65a of the rotating arm 65 toward the electromagnetic plunger 63, so that the rotating arm 65 is rotated counterclockwise, shown in FIG. 10, around the rotation support; thus, the other end 65b of the rotating arm 65 rises.

Accordingly, the lower end of the oscillating plate 44 near the recording-paper press roller 43 is forced up by the other end 65b of the rotating arm 65 against the spring force of the coil spring 45 and the recording-paper press roller 43 is therefore relatively separated from the platen roller 42. Referring to FIG. 13, the recording paper 25 is fed to the upstream carrying mechanism 22 one by one with the electromagnetic plunger 63 in the OFF position. Of the end 65b of the rotating arm 65, a corner 65c formed by one surface side along the carrying path which is to be brought into slide contact with the recording paper 25 and the end of the end 65b is chamfered. Accordingly, when the recording paper 25 is fed to the upstream carrying mechanism 22 through the one surface side of the end 65b, the downstream end in the carrying direction of the recording paper 25 can be prevented from getting caught by the end 65b of the rotating arm 65. This embodiment has a substantally similar structure to that of the above-described embodiment, thus offering substantially similar advantages.

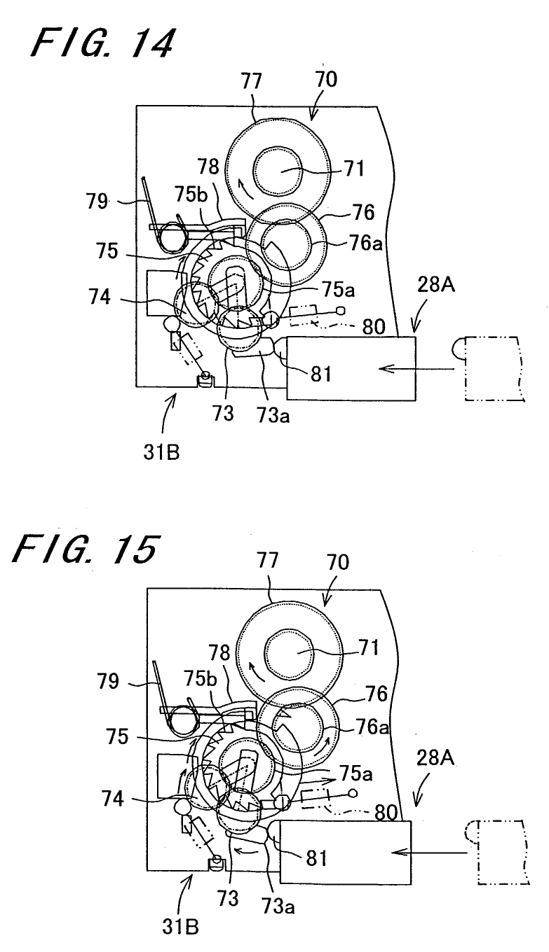

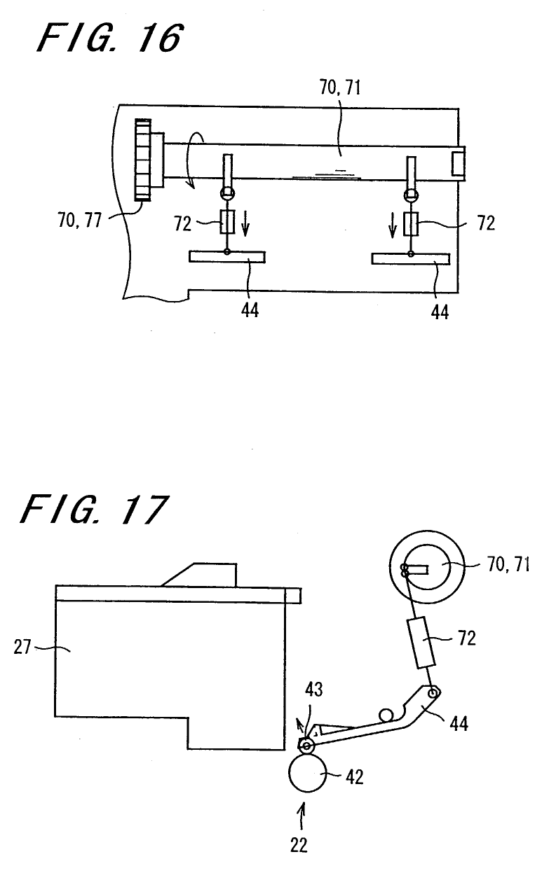

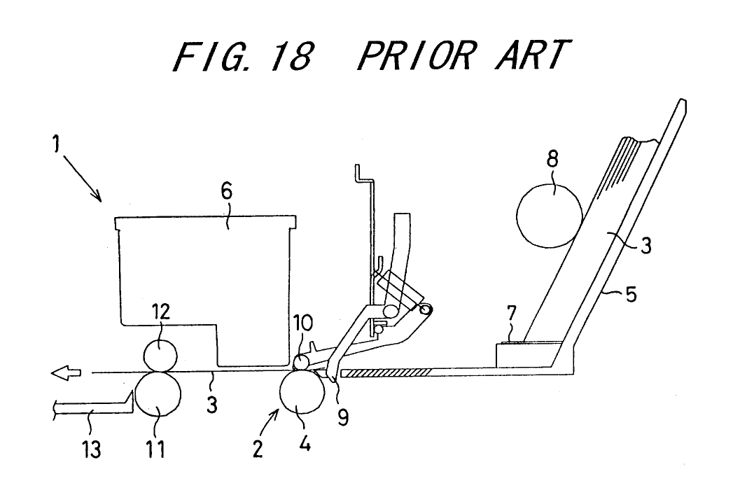

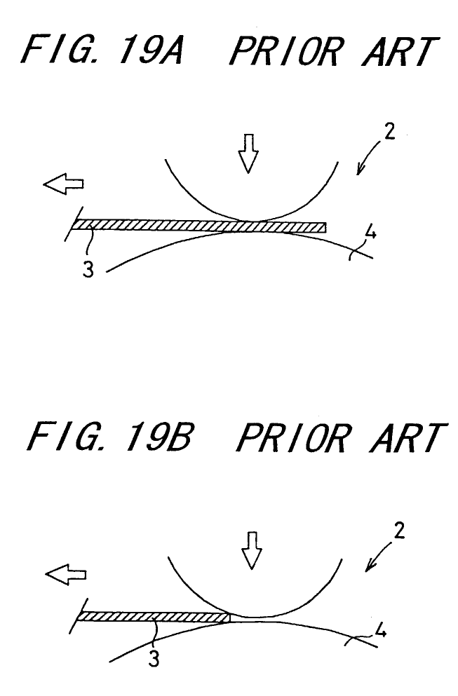

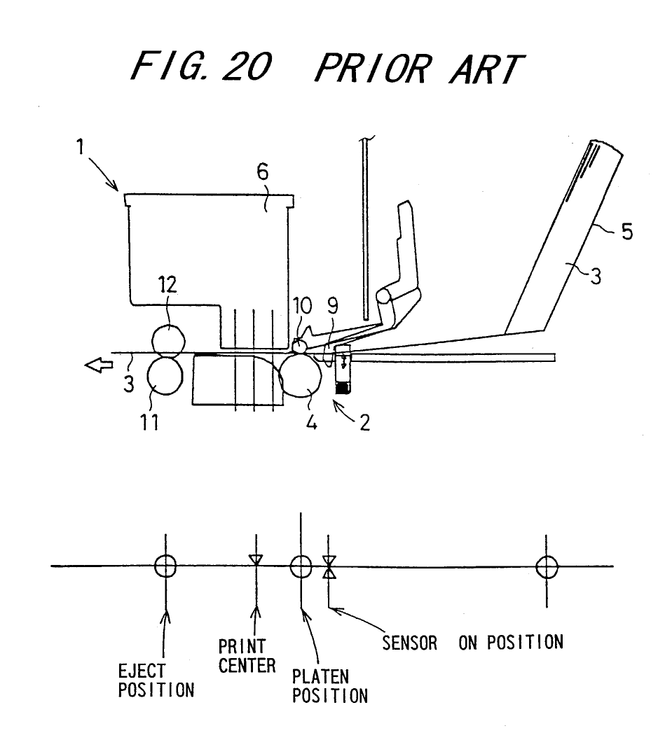

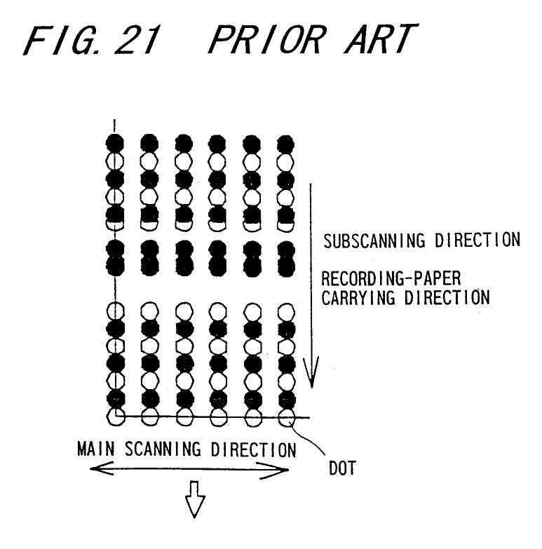

FIG. 14 is a partial side view of a release mechanism 31B and the periphery thereof according to another embodiment of the present invention; FIG. 15 is a side view showing the relationship between a drive source and a driving-force transmission mechanism 70 when the carriage-possible state of the recording medium is released; FIG. 16 is a schematic plan view showing the operation of the driving-force transmission mechanism 70 when the carriage-possible state of the recording medium is released; and FIG. 17 is a schematic side view showing the relationship between the driving-force transmission mechanism 70 and the upstream carrying mechanism 22. The same components as those of the aforesaid embodiment are given the same reference numerals and a detailed description thereof will be omitted.

In the aforesaid embodiment, a release mechanism 31B is substituted for the release mechanism 31A. The release mechanism 31B includes a carrier unit 28A serving as the drive source and a driving-force transmission mechanism 70. The carrier unit 28A primarily includes the carrier motor 28 and a carriage to which the ink cartridge 27 is disposed detachably.

The driving-force transmission mechanism 70 includes a gear mechanism, a connecting shaft 71, and a coil spring 72. The gear mechanism includes gears 73, 74, 75, 76, and 77, an antirotation arm 78, a torsion spring 79, and a coil spring 80. For example, the gear 75 is rotatably arranged in the frame. The gears 73 and 74 are rotated or revolved around the rotation shaft of the gear 75. The gears 73 and 74 are in engagement with a minor-diameter gear 75a of the gear 75, respectively, and the gears 73 and 74 can also be brought into and out of contact with each other. They are arranged apart from each other in the initial state, as shown in FIG. 14. A major-diameter gear 75b of the gear 75 has the antirotation arm 78 so as to be brought into engagement with each other. The antirotation arm 78 has the torsion spring 79, by the spring force of which the antirotation arm 78 is biased to come into engagement with the major-diameter gear 75b. The coil spring 80 is arranged between the radial outer end of the gear 75 near the carrier unit 28A and the frame member. The gear 75 is constantly pulled counterclockwise in FIG. 14 by the biasing force of the coil spring 80.

An arm 73a which extends in a certain small distance is provided to the outer side of the gear 73, to which a protrusion 81 of the carrier unit 28A is pressed. When the carrier unit 28A, that is, the carriage moves and the projection 81 presses the arm 73a, the gear 73 is rotated clockwise and revolved clockwise around the rotation shaft of the gear 75 in FIG. 14.

The gear 73 is brought into engagement with the gear 74 by the revolution. Accordingly, the gear 75 is rotated clockwise against the biasing force of the coil spring 80, and the antirotation arm 78 is forced up radially outward with respect to the gear 75 against the biasing force of the torsion spring 79. The gear 75 is then stopped in the position displaced one gear teeth. The gear 76 in engagement with the minor-diameter gear 75a of the gear 75 is rotated counterclockwise with the rotation of the gear 75. When the gear 76 is rotated counterclockwise, the gear 77 in engagement with the minor-diameter gear 76a of the gear 76 is rotated clockwise.

Accordingly, the connecting shaft 71 integrated with the gear 77 is rotated counterclockwise in FIG. 17. To the outer periphery of the connecting shaft 71, one end of the longitudinal direction of the oscillating plate 44 is connected through the coil spring 72. Thus, the biasing force of the coil spring 72 is reduced by the counterclockwise rotation of the connecting shaft 71, and so each recording-paper press roller 43 is gradually separated from the platen roller 42. In this manner, the biasing force of the coil spring 72 is reduced to release the pressing force of each recording-paper press roller 43 to the platen roller 42.

According to the embodiment described above, since the existing carrier unit 28A is used for the drive source of the release mechanism 31B, the manufacturing costs of the ink-jet printer can be reduced as compared with an arrangement that requires an additional drive source. Particularly, after the recording-paper press roller 43 that is biased to the platen roller 42 by the spring force has been separated therefrom against the biasing force by means of the release mechanism 31B, the recording paper 25 can be printed. Therefore, the print quality of the recording paper 25 can be improved with a simplified structure.

According to another embodiment of the present invention, the gear 61, the cylindrical cam 56, and the shaft 55 may be integrated in one or, alternatively, may be separated as required. The forcing arm 57 is not necessarily limited to have a cylindrical shape. Furthermore, it will be appreciated that variations and modifications can be effected without departing from the scope of the invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An image forming apparatus comprising:
recording means for recording a desired image on a recording medium;
recording-medium carrying means capable of carrying the recording means, the recording-medium carrying means including upstream carrying means arranged along a carrying path and upstream of the recording means and downstream carrying means arranged along the carrying path and downstream of the recording means;
release means capable of releasing a carriage-possible state of the recording medium in the upstream carrying means; and
control means for forcibly releasing the carriage-possible state to control a carrying force to be applied to the recording medium before the recording medium is separated downstream from the upstream carrying means, based on predetermined recording-medium carrying position information.

2. The image forming apparatus of claim 1, wherein the release means includes a drive source for applying a driving force for releasing the carriage-possible state to the upstream carrying means and a driving-force transmission mechanism for transmitting the driving force from the drive source to the upstream carrying means to release the carriage-possible state.

3. An image forming apparatus comprising:
recording means for recording a desired image on a recording medium;
recording-medium carrying means capable of carrying the recording medium, the recording-medium carrying means including upstream carrying means arranged along a carrying path and upstream of the recording means and downstream carrying means arranged along the carrying path and downstream of the recording means; and
a control mechanism for controlling a carrying force to be applied to the recording medium on the basis of predetermined recording-medium carrying position information.

4. The image forming apparatus of claim 3, wherein the control mechanism can be controlled with a drive source for maintaining the recording means.

5. The image forming apparatus of claim 3, wherein the upstream carrying means has a pair of rotating rollers which can sandwich the recording medium and can be rotated, and the control mechanism has a function of separating a first rotating roller which is elastically biased to a second rotating roller therefrom against the biasing force.

6. An image forming apparatus comprising:
recording means for recording a desired image on a recording medium;
recording-medium carrying means capable of carrying the recording medium, the recording-medium carrying means including upstream carrying means arranged along a carrying path and upstream of the recording means and downstream carrying means arranged along the carrying path and downstream of the recording means; and
release means for forcing a carriage-possible state of the upstream carrying means to be released in a state where the recording medium can be carried by the cooperation of the upstream carrying means and the downstream carrying means and in at least a stopped state before the recording medium is separated downstream from the upstream carrying means.

7. The image forming apparatus of claim 6, wherein the release means can be released with a drive source for maintaining the recording means.

8. The image forming apparatus of claim 6, wherein the upstream carrying means includes a pair of rotating rollers which can sandwich the recording medium and can be rotated, and the release means has a function of separating a first rotating roller which is elastically biased to a second rotating roller therefrom against the biasing force.
